(19) United States
(12) Patent Application Publication
(10) Pub. No.: US 2026/0133623 A1
(43) Pub. Date: May 14, 2026

(54) MOVEMENT DETECTION IN AN EXTENDED REALITY ENVIRONMENT

(71) Applicant: GOOGLE LLC, Mountain View, CA (US)

(72) Inventors: Rajeev Nongpiur, Mountain View, CA (US); Xiao Yuan, Palo Alto, CA (US); Ravi Tejasvi, San Mateo, CA (US); Kirit Narain, Mountain View, CA (US)

(21) Appl. No.: 19/385,361

(22) Filed: Nov. 11, 2025

Related U.S. Application Data
(60) Provisional application No. 63/718,987, filed on Nov. 11, 2024.

(51) Int. Cl. G06F 3/01; G01P 13/00

(52) U.S. Cl. CPC G06F 3/012; G01P 13/00

(57) ABSTRACT

Methods and systems for improved impact detection in a device, such as a head-wearable device, are disclosed. The methods and systems relate to accurately detecting impact events such as falls or vehicular crashes to reduce false positives and enable a swift, appropriate emergency response. A method includes detecting use of the device by a user, for instance, confirming that a head-wearable device is being worn. The method further includes detecting a change in at least one of an orientation or a movement of the device within a threshold time period. An impact is then determined based on the confirmed use of the device and the detected change in its orientation or movement. This approach distinguishes genuine emergencies from non-critical events like dropping the device, thereby improving accuracy and conserving power by intelligently activating additional sensors only when a potential impact is detected.

### CROSS-REFERENCE TO RELATED APPLICATION

This application claims priority to U.S. Provisional Patent Application No. 63/718,987, filed on Nov. 11, 2024, entitled “FALL AND CRASH DETECTION IN AN EXTENDED REALITY ENVIRONMENT”, the disclosure of which is incorporated by reference herein in its entirety.

### BACKGROUND

Wearable devices can be configured to identify some movements. By monitoring data from one or more sensors, these devices can sometimes detect sudden forceful movements. However, the accuracy of these systems has its limits. Differentiating between an emergency and an abrupt but harmless action, like dropping the device or a vigorous workout, can be difficult. Furthermore, there can be delays in detection and subsequent alerting, which can be critical in situations where a swift emergency response is necessary.

Disclosed herein are methods and systems for improved impact detection using a device, such as a head-wearable device. The concepts described herein provide a more accurate and reliable way to detect impact events like falls or vehicle crashes by leveraging the unique perspective and sensor suite of a device being actively used by a user, for example, worn on the user's head. By confirming the device is in use and then analyzing sudden changes in orientation or movement, the system can distinguish between genuine emergencies and non-critical events like dropping the device, thereby reducing false positives and enabling a swift, appropriate response when a true impact occurs. Moreover, by optimizing the use of power, impact detection can be performed in a more efficient and accurate manner.

In one aspect, a method is provided that includes detecting that a device is in use by a user. The method further includes detecting a change in the orientation or movement of the device within a specified time period. Based on the confirmed use of the device and the detected change in its orientation or movement, a determination is made that an impact has occurred. In some embodiments, the device is a head-wearable device, and detecting its use involves confirming that the device is being worn by the user. The method may also involve determining if the user is in a moving vehicle and factoring this context into the impact determination. Various sensors, including one or more movement sensors (e.g., inertial measurement units), cameras, microphones, and light sensors, can be activated or their data analyzed to further refine the detection of the impact event

The details of one or more implementations are set forth in the accompanying drawings and the description below. Other features will be apparent from the description and drawings, and from the claims.

### BRIEF DESCRIPTION OF THE DRAWINGS

FIG. 1A is an illustration depicting a fall event scenario where a person has collapsed on the floor.

FIG. 1B is a block diagram illustrating an exemplary system for identifying a fall event, according to at least one example implementation

FIG. 2A is a block diagram illustrating an exemplary system for identifying a fall event using fall signatures and environmental fluctuations, according to at least one example implementation.

FIG. 2B is a block diagram illustrating an exemplary system for identifying a potential fall event, according to at least one example implementation.

FIG. 2C is a block diagram illustrating an exemplary system for identifying a wear state of a device, according to at least one example implementation.

FIG. 2D is a block diagram illustrating an exemplary system for conserving power in identifying an impact event, according to at least one example implementation.

FIG. 3 is a block diagram illustrating an exemplary system for identifying an impact event, according to at least one example implementation.

FIG. 4A is a block diagram illustrating an exemplary system for generating a measurement parameter based on an impact event, according to at least one example implementation.

FIG. 4B is a block diagram illustrating an exemplary system for identifying an in-vehicle presence of a user, according to at least one example implementation.

FIG. 5 is a block diagram illustrating an exemplary computing system for impact identification, according to at least one example implementation.

FIG. 6 is a flowchart illustrating an exemplary method for determining an impact, according to at least one example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Implementations of fall and crash detection in an extended reality (XR) system such as, for example, augmented reality (AR) glasses, head mounted display (HMD) devices, and/or so forth are described herein. Current impact detection systems, particularly for wearable devices like smart watches, struggle to accurately differentiate genuine emergencies, such as falls or vehicle crashes, from harmless events like dropping the device or vigorous exercise, leading to a high rate of false positives. This invention addresses this challenge by first confirming that a device, such as a pair of AR glasses, is actively being used by a user (e.g., being worn) before analyzing sensor data for signs of an impact. By combining the context of active use with sudden changes in movement or orientation, the system significantly improves accuracy, reduces false alarms, and ensures that a swift and appropriate response is triggered only when a true impact event occurs. Furthermore, a secondary sensor such as a visual sensor may be activated when a fall or crash is detected as being imminent. By using a more accurate sensor such as a visual sensor (e.g. camera), the system can significantly improve accuracy.

Impact detection technology, which aims to identify events like a person falling or being involved in a vehicle collision, has significant life-saving potential. In everyday scenarios, the ability to automatically and quickly detect such an impact can be critical. For example, falls are often associated with serious medical events like strokes or heart attacks, and vehicle crashes can leave individuals incapacitated or disoriented. In these situations, a swift emergency response is crucial for survival and can substantially improve health outcomes. Therefore, the importance of providing accurate impact detection cannot be overstated. Equally important is the timeliness of such detection; any delay in recognizing an event and alerting emergency services can have severe consequences.

However, conventional systems for impact detection, especially those implemented in wearable devices like smart watches, present several technical problems. A primary technical problem is the high rate of false positives. These systems often struggle to reliably distinguish between a genuine emergency and other events involving sudden movements, such as dropping the device, engaging in vigorous exercise, or even abrupt but harmless user actions. This lack of accuracy leads to unnecessary alerts, eroding user trust and potentially desensitizing emergency responders. Another technical problem is that traditional systems often lack a reliable mechanism to confirm a potential detection. Without contextual information, an alert might be triggered based solely on sensor data that matches a generic impact signature, without knowing if the user was actually involved in the event.

Furthermore, another significant technical problem with existing solutions is excessive power consumption. To be effective, an impact detection system requires its sensors, such as a movement sensor (e.g., the inertial measurement unit (IMU)), to be continuously active to monitor for sudden changes in movement and orientation. Keeping these sensors constantly powered on places a substantial drain on the battery of a portable, wearable device. This makes continuous, high-fidelity monitoring impractical for all-day use and presents a major technical problem for device longevity and user convenience. Thus, there is a technical problem in balancing the need for constant vigilance with the practical constraints of battery life in a compact wearable device.

These technical problems highlight the shortcomings of conventional impact detection methods, which are often inaccurate, too slow, and power-intensive. The inability to distinguish a device being dropped from a person falling, the lack of contextual confirmation for an impact, and the impracticality of continuous high-power sensor operation have made existing solutions inadequate for widespread, reliable use, particularly in head-wearable devices where both accuracy and power efficiency are paramount.

The present disclosure provides a technical solution to the aforementioned technical problems by providing systems and methods for improved impact detection that leverage the unique context available to a device being actively used by a user. This technical solution addresses the problem of false positives and power consumption by introducing a multi-stage approach. First, the system confirms that the device is actually in use (e.g., being worn on the user's head). This initial check immediately solves the technical problem of false alarms caused by a dropped device, as the system can differentiate between an impact affecting the user and an impact affecting only the device itself.

The proposed technical solution further addresses the identified technical problems by using a combination of sensors and contextual information to verify an impact event. Once the device is confirmed to be in use, the system monitors for changes in orientation or movement that match a potential impact signature. This can trigger the activation of other sensors, such as a camera or microphone, only when a potential impact is detected, thereby solving the technical problem of high-power consumption from continuous sensor operation. This approach allows the device to remain in a low-power state, activating more resource-intensive sensors for brief periods only when necessary. The system may also determine the user's context, such as whether they are in a moving vehicle, to further refine the accuracy of crash detection and distinguish it from other types of impacts.

Furthermore, to address the technical problem of high-power consumption associated with continuous monitoring, the system may be implemented using a low-power microcontroller (MCU)-centric architecture. In such architecture, the main Application Processor (AP), which is a significant source of battery drain, may be bypassed for routine monitoring tasks. Instead, sensors such as the IMU, proximity sensor, light sensor, visual sensor and/or microphone, may be connected directly to a low-power MCU. This design enables the system to maintain continuous vigilance for impact events without the impractical power draw associated with keeping the main AP continuously active.

Moreover, the sensors built into, for example, AR glasses (e.g., IMU, proximity, light sensor, microphones, cameras) are well suited to detect the sudden movements, sounds, and visual changes associated with a crash and/or fall. Moreover, head-wearable devices (e.g., AR glasses), can be configured to observe the world like a human, providing a more accurate and reliable fall detection than phone or wrist-worn devices. As another example, head-wearable devices can be configured to experience the world much like a human wearer does, and this unique perspective can allow for more accurate crash detection compared to traditional vehicle-based sensors.

This approach yields several advantageous technical effects. A primary technical effect is a significant improvement in detection accuracy. By first verifying that the device is being worn, the system effectively eliminates a major source of false positives (i.e., dropped devices), making the alerts it generates more reliable and trustworthy. Furthermore, by activating a secondary sensor such as a camera or microphone, the system can verify the accuracy of impact detection before providing a notification. Another technical effect is the substantial reduction in power consumption. By intelligently activating sensors only in response to a potential fall or crash, the system can provide continuous protection without the impractical battery drain associated with always-on monitoring, thereby improving the device's overall usability.

Ultimately, the key technical effect of this invention is the provision of a more robust, efficient, and practical impact detection system for wearable devices. The methods described herein enable a faster and more appropriate emergency response by ensuring that alerts are triggered for genuine emergencies. By leveraging the unique perspective of a head-wearable device and combining signals from multiple sensors in a power-conscious manner, this technical solution enhances user safety and provides a level of reliability that conventional systems have failed to achieve.

At least one technical effect or benefit of these technical solutions is improved fall and/or crash detection in a variety of applications. For example, fall and/or crash detection can be used in a variety of situations including, for example, life-threatening cases (e.g., falls and/or crashes are often caused by strokes, heart attacks, or accidents, making a swift emergency response crucial for survival), instant alerts (e.g., AR glasses automatically or autonomously notify emergency services the moment a fall and/or crash happens, overcoming the delays caused by incapacitation or disorientation), and/or so forth. The odds of surviving a severe vehicular crash significantly increase when medical attention arrives quickly, and AR glasses can play a pivotal role in accelerating emergency response.

Beyond the immediate life-saving potential of alerting emergency services, this enhanced impact detection system has a variety of practical applications that can significantly improve user safety and peace of mind across different scenarios. For elderly individuals or those with medical conditions that increase the risk of falling, a head-wearable device with this technology can offer constant, reliable monitoring. The system can distinguish between a user simply setting their glasses down on a nightstand versus an actual fall from bed, ensuring that an alert is only sent when truly needed. This provides a more dignified and less intrusive safety net, allowing for greater independence while still ensuring that help is dispatched quickly in a genuine emergency. The power-efficient design is particularly important, enabling all-day and all-night protection without the constant need for recharging.

Furthermore, the technology finds compelling applications in high-activity and industrial environments. For instance, athletes participating in extreme sports like mountain biking or skateboarding can benefit from automatic crash detection that a phone or watch might miss or misinterpret. In an industrial setting, a construction worker or a lone technician operating in a remote area would have an added layer of safety. If a fall occurs from a ladder or a vehicle-related accident happens on a large work site, the device could not only alert supervisors but also provide precise location data, drastically reducing response times. The system's ability to factor in contextual data, such as whether the user is in a vehicle, makes it uniquely suited for these diverse environments where the nature of a potential impact can vary greatly.

An impact can refer to a detectable event signature within sensor data, characterized by a rapid, high-magnitude transient in one or more sensor readings that exceeds a predetermined threshold. This signature corresponds to a physical high-force event, such as a fall or a vehicle crash, and can be identified by analyzing data from sensors such as an IMU for rapid (e.g., sharp, movements satisfying one or more criterion) accelerations and/or decelerations, a microphone for impulsive sounds, or a light sensor for sudden environmental changes. In some implementations, an impact can refer to a high-force event, such as a fall or a vehicle crash, that is computationally identified by detecting a sudden, significant change in sensor data corresponding to the device's movement, orientation, or environment. A rapid acceleration, a rapid deceleration and/or a sharp movement may refer to a change in speed that is greater than a criterion (e.g., a threshold).

In some implementations, the system can be configured to identify acceleration and/or deceleration by analyzing the sensor signals from, for example, a sensor (e.g., an IMU). For example, a high-magnitude acceleration followed by a rapid deceleration can be detected from the IMU data, which provides a characteristic movement pattern indicative of an impact. Such a movement pattern, which may be referred to as an impact signature, can be used to distinguish a high-impact event, such as a fall or a crash, from normal user movements. Different types of impacts may have distinct signatures. For example, the deceleration profile of a vehicular crash may differ significantly from the free-fall and impact signature of a person falling.

This characteristic movement pattern may be stored in a movement profile, which can be used by a classifier or decision logic to identify an impact event. A movement profile may define the specific parameters of an impact, including the magnitude, duration, and sequence of movements. For instance, specific criterions (e.g., thresholds) for acceleration and/or subsequent deceleration may be included in a movement profile. By comparing the real-time sensor data against one or more stored movement profiles, the system can determine with a higher degree of accuracy whether the detected movements correspond to a genuine impact event.

In some impact scenarios, the characteristic movement pattern may involve a period of acceleration that precedes the primary deceleration event. For example, in a vehicular context, if a user's vehicle is struck from behind, the initial impact will impart a sudden forward acceleration. This acceleration phase would then be followed by a rapid deceleration as the vehicle collides with an object in front of it, or as braking is applied. A similar sequence can occur in non-vehicular contexts, such as a fall where a user is pushed or stumbles forward, resulting in a brief acceleration before the deceleration caused by the impact with the ground. The movement profiles can be configured to detect these specific acceleration-then-deceleration signatures, thereby enabling the system to accurately identify a broader range of impact events.

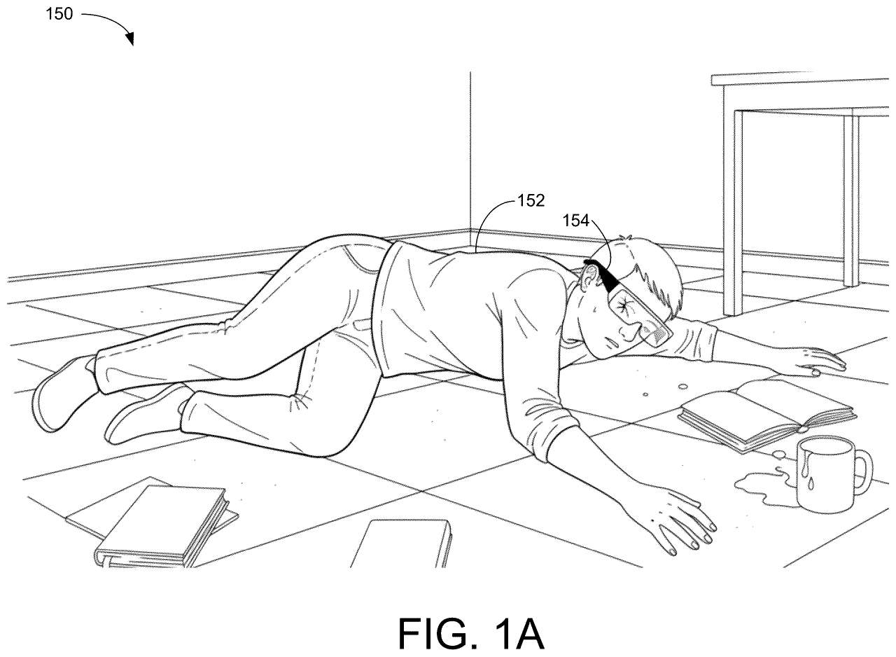

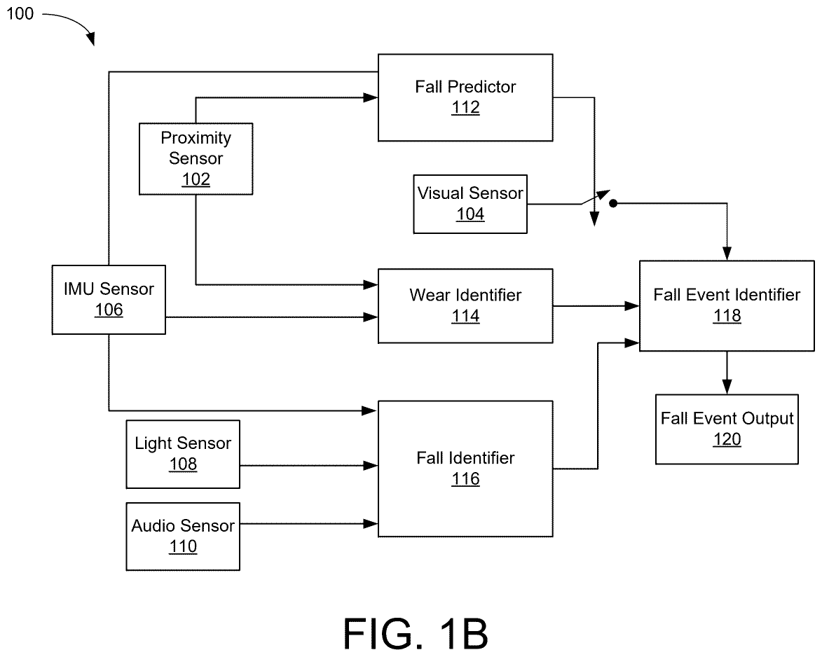

FIG. 1A is an illustration depicting a fall event scenario where a person has collapsed on the floor. FIG. 1A depicts an environment 150 illustrating an example of a fall event involving a user 152. As shown, the user 152 wearing a head-wearable device 154 (e.g., smart glasses or goggles) has collapsed on a tiled floor. The individual is lying on their side and stomach, with objects such as an open book, a stack of closed books, and a spilled mug scattered nearby. This scene represents a scenario where the disclosed system can detect an impact event. The head-wearable device 154 worn by the user 152 can leverage its suite of sensors to identify the sudden changes in orientation and movement characteristic of the fall, as well as contextual cues like the impact sound or changes in ambient light, to verify the fall. In an example, the head-wearable device 154 can determine an imminent fall and turn on its camera to capture an image or video of the user as the user is falling or soon after the user has fallen. The image(s) and/or videos may be used to verify the event as an actual fall event before triggering an emergency alert.

FIG. 1B provides a block diagram illustrating an exemplary system 100 for identifying a fall event. The system 100 integrates data from various sensors to analyze a user's state and detect a fall. The system 100 includes several modules that process sensor inputs to determine if a fall has occurred and generate a corresponding output. These modules include a fall predictor 112, wear identifier 114, fall identifier 116, and a fall event identifier 118, which synthesizes information from the other modules.

The system 100 utilizes a suite of sensors to gather contextual information. A proximity sensor 102 and an Inertial Measurement Unit (IMU) Sensor 106 provide input to both the fall predictor 112 and wear identifier 114. The wear identifier 114 uses data from the proximity sensor 102 and IMU sensor 106 to confirm that a device such as a head-wearable device (e.g., AR glasses) is actively being worn by the user. This step is important for distinguishing between a genuine fall event and an instance where the device itself is merely dropped, thereby reducing false positives. For example, the proximity sensor 102 can detect if the device is against the user's skin, while the IMU sensor 106 can identify characteristic head movements associated with active use. In some implementations, other sensors such as the light sensor 108 and audio sensor 110 are not activated unless the wear identifier 114 determines that the device is being worn by the user. This helps the system conserve power and computing resources.

The IMU sensor 106 may be a motion sensor, which may be implemented as an accelerometer, a gyroscope, and/or magnetometer, some of which may be combined to form the IMU sensor. In some examples, the motion sensor may be implemented as a three-axis motion sensor such as, for example, a three-axis accelerometer or a three-axis gyroscope, where the motion signals captured by the motion sensor describe three translation movements (i.e., x-direction, y-direction, and z-direction) along axes of a world coordinate system. In some examples, the motion sensor may be implemented as a six-axis motion sensor such as, for example, an IMU that has six (6) degrees of freedom (6-DOF), which can describe three translation movements (i.e., x-direction, y-direction, and z-direction) along axes of a world coordinate system and three rotation movements (i.e., pitch, yaw, roll) about the axes of the world coordinate system.

In some implementations, the proximity sensor 102 is an optical proximity sensor. The proximity sensor 102 may be located on a portion of the device that touches a user's skin (e.g., in one or both of the temple arm portions of a head-wearable device). The proximity sensor may detect proximity of the device to a human user.

Concurrently, the fall predictor 112 processes data from the same sensors—proximity sensor 102 and IMU sensor 106—to assess the likelihood of an imminent fall. By analyzing movement patterns for sudden decelerations or orientation changes characteristic of a loss of balance, the fall predictor 112 can determine if a potential fall is underway. This predictive capability allows the system to activate other, more power-intensive sensors just before or during an impact. The output of the fall predictor 112 can trigger a visual sensor 104 (e.g., a camera) to power on and begin capturing data. The visual sensor 104 may be activated only when needed to conserve power. The visual sensor 104 may remain active for a limited time period in order to conserve power and storage space.

The fall identifier 116 is responsible for analyzing signals directly associated with the impact of a fall. The fall identifier 116 receives input from the IMU sensor 106 to detect sharp accelerations and impacts such as sharp changes in orientation and movement, from a light sensor 108 to detect abrupt changes in ambient light (e.g., falling from a bright area to a dark floor), and from an audio sensor 110 to identify sounds like a thud that often accompany a fall.

Finally, the fall event identifier 118 serves as the central decision-making module. It receives and integrates the outputs from the wear identifier 114 (confirming the device is on the user), the fall identifier 116 (confirming impact characteristics), and the fall predictor 112. The fall event identifier 118 may also use data from the now-activated visual sensor 104 to further verify the event. By combining these multiple streams of contextual and impact data, the fall event identifier 118 makes a final determination about whether a fall has occurred and, if confirmed, generates a fall event output 120, which can be used to trigger an alert or notify emergency services. By using sensors such as the visual sensor 104 and audio sensor 110, the fall event identifier 118 can make significantly more accurate fall event identifications than merely using data from the proximity sensor 102, IMU sensor 106 and/or light sensor 108.

Some of these implementations can provide various technical advantages such as a significant reduction in power consumption and enhanced accuracy. By leveraging the wear identifier 114 to confirm the device is being worn before activating more power-intensive components, the system avoids the battery drain associated with continuous operation of sensors like the visual sensor 104 and audio sensor 110. This intelligent, tiered activation conserves power. Furthermore, the use of a fall predictor 112 allows for predictive sensor activation, ensuring that crucial data is captured at the moment of impact without unnecessary prior operation. This multi-modal approach, which synthesizes data from multiple sources including the IMU, visual, and audio sensors, solves the technical problem of false positives common in systems that rely on a single data stream, resulting in a more reliable and efficient fall detection system.

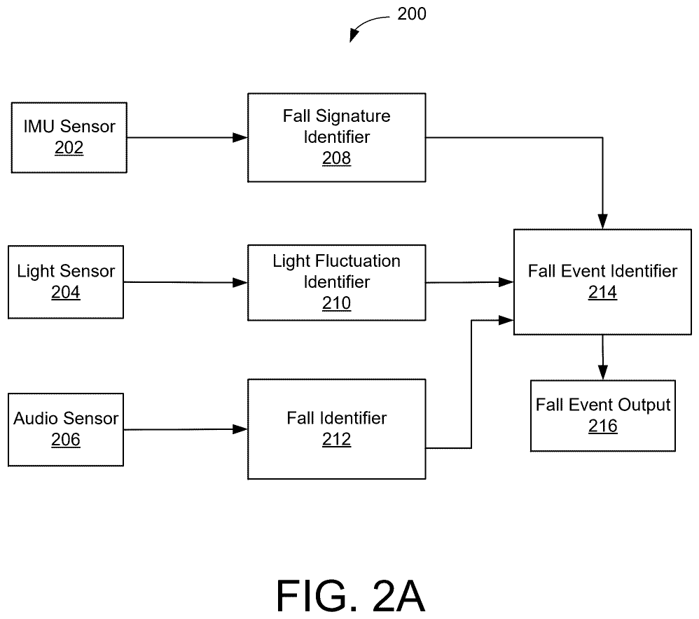

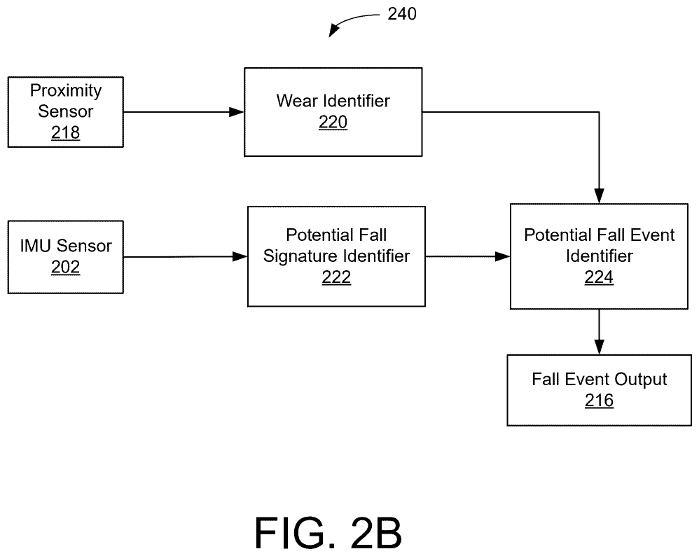

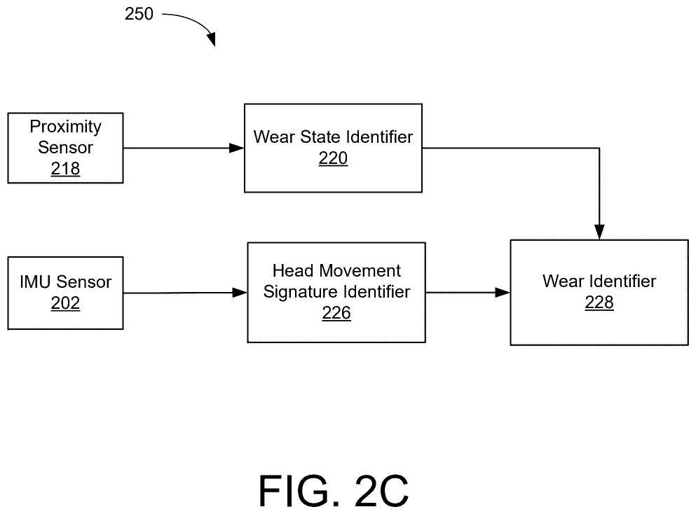

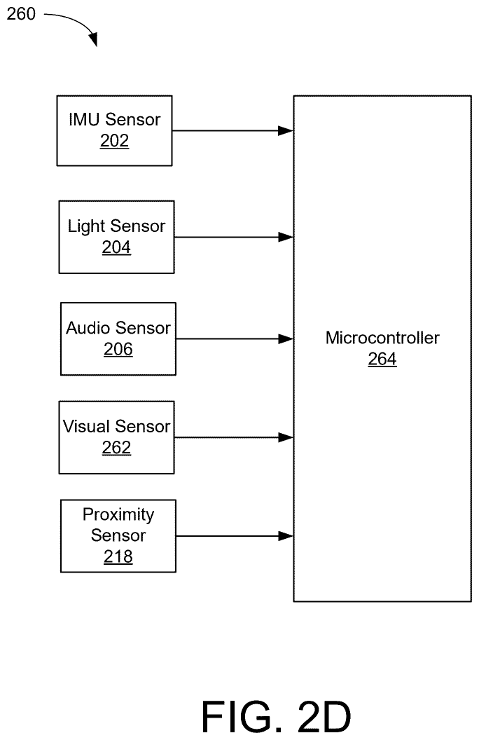

FIG. 2A is a block diagram illustrating an exemplary system 200 for identifying a fall event by analyzing fall signatures and environmental fluctuations, according to at least one example implementation. The system 200 illustrates an alternative implementation in which a visual sensor and/or proximity sensor is not used during the fall identification process, for example to preserve privacy. The system 200 includes an IMU sensor 202, a light sensor 204, and an audio sensor 206, which provide data to corresponding identifier modules.

The fall signature identifier 208 receives data from the IMU sensor 202. This module is configured to analyze movement data (e.g., changes in movement and orientation), specifically searching for patterns or signatures indicative of a fall, such as a sudden change in orientation and movement, rapid deceleration, or a sharp impact. For instance, it can detect the freefall and subsequent impact characteristics of a user falling. Sudden changes in orientation or movement may refer to a change that satisfies a criterion. For example, the change in acceleration or deceleration during a given time period may exceed a threshold, indicating that this is likely a fall. In another example, the degree of deceleration may exceed a predetermined threshold (e.g., the speed changes during a short time period from a normal walking speed to close to zero). This may indicate an abrupt change in speed or an abrupt stop. This may involve the use of a classifier or artificial intelligence (AI) model that examines the movement data and determines if the data corresponds with a signature indicative of a fall.

Concurrently, the light fluctuation identifier 210 processes data from the light sensor 204. This module is configured to detect abrupt changes in ambient light that often accompany a fall, such as a user falling from a brightly lit area to a dark floor, which would cause a significant and rapid drop in measured light intensity. The light fluctuation identifier 210 may include a classifier or an AI model for examining and identifying light fluctuations indicative of a fall.

The audio sensor 206 provides input to a fall identifier 212 (which in some implementations may be a fall sound identifier). This module is configured to listen for and identify specific sounds associated with falls, such as a distinct thud. Specific sounds associated with falls may be predetermined. For example, the sounds may have predetermined ranges in frequency, volume, pitch, timbre, and the like. The fall identifier 212 may examine various characteristics of the audio input and/or examine changes in the characteristics over given time periods (e.g., various time windows) to identify features that are associated with a fall. This may involve the use of a classifier or AI model that examines the audio data and determines if the data corresponds with a signature indicative of a fall sound.

The outputs from the fall signature identifier 208, the light fluctuation identifier 210, and the fall identifier 212 are transmitted to a central fall event identifier 214. This module serves as a decision logic block that combines the data from the different sensor streams. By synthesizing evidence of a fall signature (from IMU data), a significant light change, and an impact sound, the fall event identifier 214 can make a final, more accurate determination of whether a fall has occurred. In some implementations, the fall event identifier 214 examines a combination of the fall signature output, light changes and impact sounds to identify a fall. For example, if the fall signature output indicates a fall, but there is no light changes and no impact sounds, the fall event identifier 214 may determine that the fall signature output is a false positive. This helps reduce false positive identifications, since multiple signals are examined to verify a fall event. If a fall is confirmed, the fall event identifier generates a fall event output 216, which could be used to trigger an emergency alert.

FIG. 2B is a block diagram illustrating an exemplary system for identifying a potential fall event, according to at least one example implementation. The system 240 is designed to predict an imminent fall, which can allow for the proactive activation of other sensors to confirm the event. The system 240 illustrates an alternative architecture for identifying a fall or imminent fall. The system 240 shown in FIG. 2B includes modules for detecting that the device is being worn and for recognizing movement patterns that are characteristic of the start of a fall, ultimately leading to a fall event output if a potential fall is identified.

The system 240 relies on inputs from two primary sensors to assess the likelihood of a fall. The first is a proximity sensor 218, which provides data to a wear identifier 220. The purpose of the wear identifier 220 is to verify that the smart glass device is actually being worn by the user. This is an important first step in the process, as it helps to distinguish a user falling from an event where the device is simply dropped or moved abruptly while not in use, thereby preventing a common source of false positives. By confirming the wear state, the system ensures it is monitoring the user and not just the device's independent state.

The second sensor input comes from an IMU sensor 202, which feeds data into a potential fall signature identifier 222. This module is responsible for analyzing the movement data from the IMU sensor 202 to recognize patterns indicative of an impending fall. For instance, the potential fall signature identifier 222 might detect a sudden, uncontrolled deceleration or a rapid change in orientation that matches the profile of a person losing their balance. This module does not wait for a final impact but instead looks for the precursor movements that signal a fall is likely in progress. The potential fall signature identifier 222 may make use of a classifier, model and/or other mechanisms to identify potential fall events.

The outputs from both the wear identifier 220 and the potential fall signature identifier 222 are then integrated and processed by a potential fall event identifier 224. This final module synthesizes the information to make a determination. The potential fall event identifier 224 combines the confirmation that the device is being worn (from wear identifier 220) with the detection of a fall-like movement pattern (from potential fall signature identifier 222). If both conditions are met, the potential fall event identifier 224 concludes that an imminent fall is likely. Based on this determination, the potential fall event identifier 224 generates a fall event output 216. This output can then be used to trigger other system actions, such as activating a camera for a brief period to capture visual data of the event, thereby providing further confirmation while conserving power. In some implementations, the latency of system 240 can be configured to be fast enough that it could turn on the camera during the fall.

FIG. 2C is a block diagram illustrating an exemplary system for identifying a wear state of a device, according to at least one example implementation. The system 250 is important for confirming that the device, such as a head-wearable device, is being actively used by a user before proceeding with resource-intensive fall or crash detection, thereby reducing false positives caused by, for example, a dropped device, and reducing the user of power and computing resources.

The wear state identification system 250 includes two main inputs, data from a proximity sensor 218 and data from an IMU sensor 202. The system 250 processes the data from these sensors using specialized sub-modules to determine if the device is confirmed to be worn by the user. The proximity sensor 218 feeds its signal into the wear state identifier 220 which is configured to use the proximity sensor data to verify whether the smart-glasses are physically being worn by the user. This typically involves detecting if the device is positioned close to the user's skin or head, providing a binary or near-binary input regarding the current on/off state of the device. This may involve use of known wear state detection mechanisms such as classifiers or AI models that are trained for identifying the wear state of wearable electronics.

Concurrently, the IMU sensor 202 transmits movement data into the head movement signature identifier 226. This identifier is designed to analyze movement patterns (such as acceleration, velocity, and orientation changes) characteristic of a user wearing the device on their head and engaging in typical activities, like looking around or walking. This component differentiates the movement of a worn device (i.e., movement correlated with a user's head movements) from random device motion (i.e., the device being carried, dropped, or placed on a stationary surface). To achieve this, head movement signature identifier 226 may make use of an AI model trained for identifying head movements. The use of the head movement signature identifier 226 confirms wear state detection by ensuring that the output from the proximity sensor 218 is accurately identified as indicating a wear state.

The outputs of both the wear state identifier 220 and the head movement signature identifier 226 converge and are subsequently fed into the wear identifier 228. The wear identifier 228 serves as the final decision logic for confirming active use. It combines the sensor data streams, correlating the positive wear state detected by the proximity sensor 218 with the characteristic head movements identified by the IMU sensor 202. By synthesizing these multiple inputs, the wear identifier 228 generates a definitive signal confirming if a human is currently wearing the head-wearable device. This layered confirmation ensures a high level of accuracy for the glass-on-user detection, providing the necessary contextual information for the overall fall and crash detection system to function efficiently and accurately.

In some implementations, the system's contextual awareness can extend beyond simply determining whether the device is being worn to also ascertain the specific type of use or activity the user is engaged in. For example, the system may identify if the user is involved in physical activity (e.g., running or other vigorous exercise), interactive gaming, or driving a vehicle. Each of these activities is associated with a distinct set of normal movements and potential impact scenarios. Accordingly, the movement profile or impact signature used for detection can be dynamically selected or modified based on this contextual information. The acceleration and deceleration thresholds that define an impact for a user engaged in athletic activity, for instance, would differ significantly from the profile used for a user driving a car, thereby allowing the system to more accurately distinguish between expected movements and a genuine impact event. The system may identify the type of activity based on sensor data and/or based on the type of application the user is utilizing on the device.

In some implementations, by analyzing the frequency, magnitude, and/or consistency of sensor signals from a movement sensor (e.g., an IMU), the system can distinguish between lower-impact physical activities like walking and higher-impact physical activities like running. Each of these activities may have a unique movement profile associated with it. The rhythmic impact of a foot-strike while running generates a significantly different acceleration signature than a casual walking gait. Consequently, a fall that occurs during a run will have a different impact signature compared to a simple trip and fall while walking. By correctly identifying the user's current physical activity, the system can select the most appropriate movement profile, enabling it to more accurately differentiate a genuine impact from the normal, expected movements of that activity, thereby enhancing detection reliability

FIG. 2D is a block diagram illustrating an exemplary system for conserving power in identifying an impact event, according to at least one example implementation. The system 260 depicts an example of data from each of the IMU 202, light sensor 204, audio sensor 206, visual sensor 262 and proximity sensor 218 being directly provided to a microcontroller 264 for processing. The operational flow of this architecture may utilize a staged, intelligent sensing approach. In a first low-power stage, the microcontroller 264 continuously monitors the data streams from each of the IMU 202, light sensor 204, audio sensor 206, visual sensor 262 and proximity sensors 218. This continuous monitoring allows the microcontroller 264 to perform preliminary analysis, such as confirming that the device is being worn by the user and detecting initial signatures that may indicate a potential fall or crash, such as sudden changes in movement and orientation. By handling these constant monitoring tasks, the microcontroller 264, which uses less power than the main AP, ensures that the system is responsive while consuming reduced energy.

This approach avoids waking the high-power main AP for routine monitoring. The microcontroller 264 handles the continuous monitoring tasks, thus enabling continuous impact identification without significant battery drain. Furthermore, by processing sensor data directly on the microcontroller 264, the system 260 can detect the signatures of an impact (e.g., from the IMU 202) quickly, thus speeding up the total processing time from event to detection.

A technical effect of this microcontroller-centric design is the intelligent management of high-power sensors, such as the visual sensor 262. The visual sensor 262, which typically has the highest power consumption, may remain off by default to conserve energy. The microcontroller 264 may be programmed to activate the visual sensor 264 only when some of the other low-power sensors detect a high probability of an impact event. This activation can occur predictively, to capture the event as it happens, or for post-event confirmation. This event-triggered activation provides robust, multi-modal verification of an impact while achieving the technical effects of ultra-low power consumption and reduced system latency.

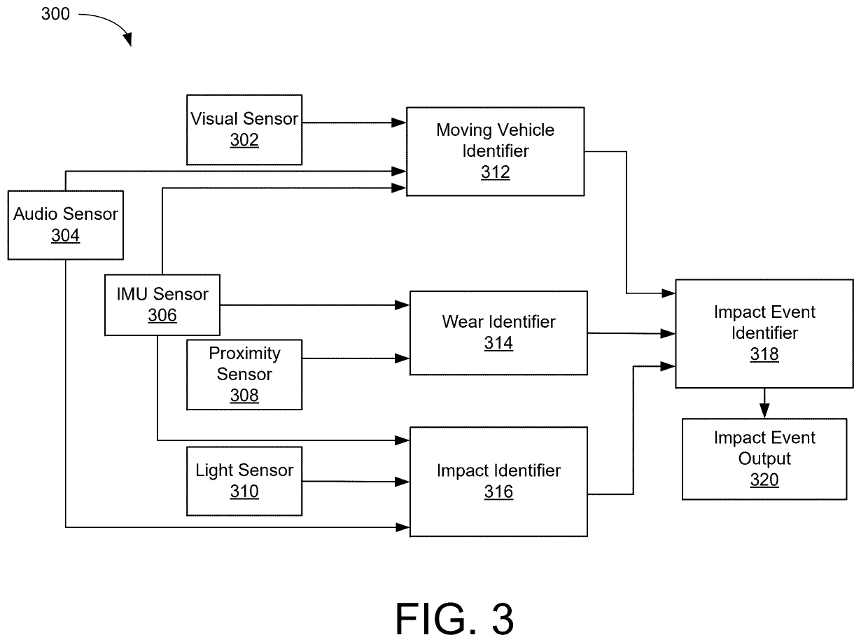

FIG. 3 is a block diagram illustrating an exemplary system for identifying an impact event, according to at least one example implementation. The system 300 is designed to determine when an impact, such as a fall or a vehicular crash, has occurred based on multi-sensor data and contextual checks, particularly whether the device is in use and whether the user is in a moving vehicle.

The system 300 includes multiple specialized modules that process data from a suite of sensors to provide a comprehensive analysis of the situation. By combining data from a wear identifier 314, a moving vehicle identifier 312, and an impact identifier 316, the system 300 addresses the challenge of accurately distinguishing a genuine impact event from harmless occurrences.

The wear identifier 314 is a module that receives input from an IMU sensor 306 and a proximity sensor 308. The wear identifier 314's function is to verify that the device, such as a head-wearable device (e.g., augmented reality (AR) glasses), is actively being worn by the user. By ensuring the device is on-user, the system immediately filters out false positives that would result from merely dropping the device on a surface. The wear identifier 314 may operate similarly to the wear state identifier 220 of FIG. 2C to determine a wear state of the device.

The moving vehicle identifier 312 determines the contextual environment of the user. This identifier receives inputs from a visual sensor 302 and/or an audio sensor 304. By analyzing visual data (e.g., image or video data) and ambient sounds (audio data), this module assesses whether the device-wearing user is currently inside a vehicle (or on a moving vehicle such as a bicycle) that is in motion. In some implementations, the moving vehicle identifier 312 may also use input from the IMU sensor 306 to determine whether the user is in a moving vehicle by examining movement data such as the speed and/or orientation of movement. The determination of whether the user is in a moving vehicle can be used for distinguishing between high-impact events such as a fall versus a vehicular crash. In some implementations, the moving vehicle identifier 312 can operate effectively even if one of the sensor inputs, such as the visual sensor 302 or audio sensor 304, is deactivated due to privacy settings, energy preservation or computational limitations.

The impact identifier 316 is specifically configured to monitor the device for sudden, forceful impacts characteristic of a fall or crash. The impact identifier 316 receives inputs from the audio sensor 304, the IMU sensor 306, and/or a light sensor 310. The IMU data is processed to detect impact signatures such as abrupt, characteristic changes in movement and orientation, while the audio data searches for impulsive sounds (like a thud or collision noise), and the light sensor data detects sudden light fluctuations, such as falling from a brightly lit environment to a dark floor.

The final and central element of the system 300 is the impact event identifier 318. This module integrates the processed outputs from the three upstream modules: the wear identifier 314, the moving vehicle identifier 312, and the impact identifier 316. By combining this rich set of contextual information (wear state and vehicle context) with the objective measurement of the impact itself, the impact event identifier 318 can ascertain with high confidence whether a true crash or fall has occurred.

The integration logic within the impact event identifier 318 may leverage various analytical approaches, such as complex signal processing or machine learning models (e.g., neural networks or decision logic), to analyze the concurrent states provided by the input modules. For example, if the wear identifier 314 confirms the device is being worn, the moving vehicle identifier 312 confirms the user is in a vehicle, and the impact identifier 316 detects a sound associated with a crash and/or a severe movement signature, the impact event identifier 318 would likely determine that a crash has transpired.

Conversely, if the impact identifier 316 registers an impact signature, but the wear identifier 314 indicates the device is not being worn (or recently detected a “doff” state), the impact event identifier 318 can dismiss the event as a non-critical instance of the device being dropped. This hierarchical structure significantly reduces the occurrence of false positive alerts.

Once the impact event identifier 318 confirms a high-probability impact, it generates an impact event output 320. This output signal can be used to autonomously trigger immediate, appropriate actions, such as sending an emergency notification to predefined contacts or alerting emergency services with precise location information, accelerating critical response times.

In some implementations, the system may further enhance detection accuracy by receiving and processing sensor data from multiple devices associated with the user. For instance, sensor data may be provided by both an IMU sensor on a head-wearable device and an IMU sensor on a separate wrist-wearable device, such as a smart watch. The system may analyze these two data streams using different movement profiles, recognizing that different parts of the user's body, such as the head and an arm, will exhibit distinct movement patterns during an impact. The combination of these different movement signatures can provide a more comprehensive and reliable assessment, allowing the system to determine with greater accuracy whether a genuine impact event has occurred.

Some of these implementations can provide various technical advantages such as enhanced contextual awareness and improved power management. The moving vehicle identifier 312 provides a significant technical benefit by enabling the system to differentiate between different types of impact events. For example, by confirming that the user is inside a moving vehicle, the system can apply a crash-specific impact signature model, leading to higher accuracy in vehicle collision detection. Conversely, if the user is not in a vehicle, the system can use a fall-specific model, thereby reducing ambiguity and false positives across different scenarios. This contextual differentiation is a technical improvement over single-model systems that struggle to distinguish between falls, crashes, and other high-impact events.

Furthermore, a key technical advantage stems from the hierarchical and event-triggered processing architecture. By first verifying the on-user state via the wear identifier 314, the system effectively solves the technical problem of false alerts triggered by dropping the device. This initial check acts as a power-efficient gatekeeper, ensuring that more computationally expensive modules, such as the moving vehicle identifier 312 and the impact event identifier 318, are only engaged when necessary. This layered approach ensures that resources are allocated intelligently, leading to a robust, accurate, and power-efficient impact detection system well-suited for battery-constrained wearable devices.

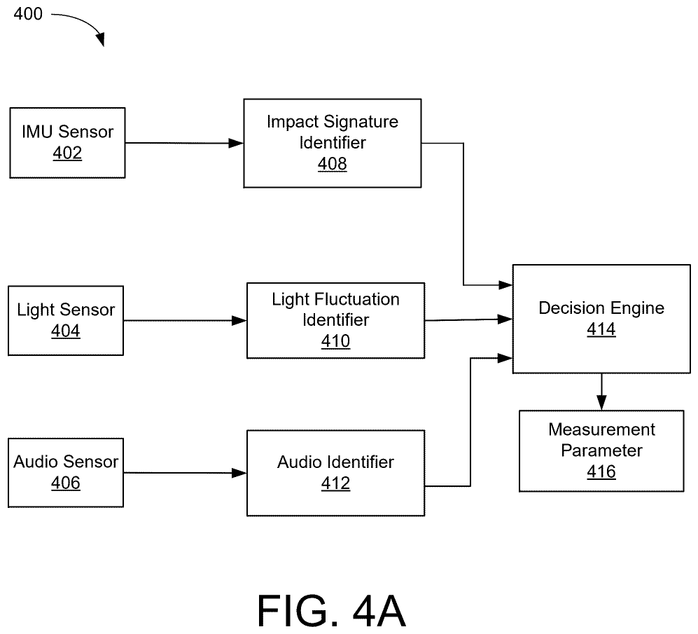

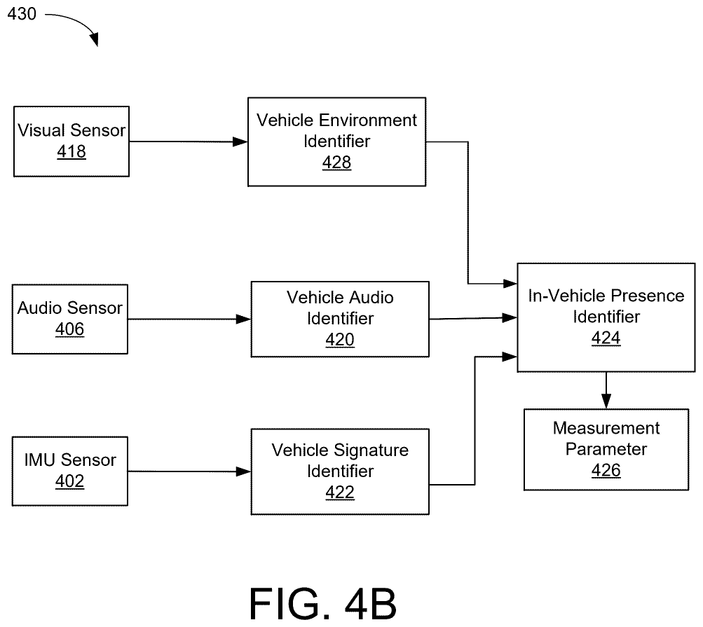

FIG. 4A is a block diagram illustrating an exemplary system for generating a measurement parameter based on an impact event, according to at least one example implementation. The measurement parameter generated by the system 400 can be used in the context of a crash or collision. The system 400 is designed to analyze data from multiple sensors to determine if a high-impact event has occurred and to quantify its characteristics. This system may function as a core component within a larger crash detection architecture, such as the one described in FIG. 3, by providing the detailed impact analysis necessary for a final event determination. In an example, the system 400 may identify impacts by using fewer components than the system 300 of FIG. 3. In another example, the system 400 may be used when a privacy concern and/or computational limitation leads to the deactivation of audio and/or video inputs.

The system 400 receives inputs from several sensors integral to a head-wearable device. An IMU sensor 402 provides movement data to an impact signature identifier 408. This module is configured to analyze the IMU data to detect specific patterns or signatures characteristic of a sudden, forceful impact, such as the rapid deceleration associated with a vehicular crash. It searches for specific signatures that align with the characteristics of high-impact events and distinguishes them from ordinary movements. To achieve this, the impact signature identifier 408 may make use of classifier(s), AI models, and/or other mechanisms. In an example, the impact signature identifier 408 uses a trained AI model trained for identifying impact signatures based on IMU movement data.

Concurrently, a light sensor 404 provides input to a light fluctuation identifier 410. The light fluctuation identifier 410 may be responsible for detecting abrupt and significant changes in ambient light that often accompany a crash event, for example, the sudden darkness caused by an airbag deployment or the rapid changes in light and shadow if a vehicle rolls over.

An audio sensor 406 provides sound data to an audio identifier 412, which functions as an impulsive sound detector. This module analyzes the microphone signals to identify the sharp, loud sounds, such as the noise of screeching tires or metal colliding, that are typically produced during a crash. Thus, the audio identifier 412 analyzes the audio data received from the audio sensor 406 to identify specific audio sounds that are indicative of a crash.

The outputs from the impact signature identifier 408, the light fluctuation identifier 410, and the audio identifier 412 are transmitted to a central decision engine 414. This engine, which can be implemented using signal processing logic, a machine learning model, a classifier and/or a state diagram, synthesizes the multiple data streams to make a final determination about the occurrence and severity of an impact. By combining data on movement, light, and sound, the decision engine 414 can make a more accurate assessment than any single sensor could alone. Based on this integrated analysis, the decision engine 414 may generate a measurement parameter 416, which could be a probability score or other metric that quantifies the likelihood and nature of the crash event. The measure parameter 416 may be used as a final output for identifying crash events or it may be used as a parameter in a higher-level system to trigger an alert.

Some of these implementations can provide various technical advantages such as enhanced data fusion and improved decision accuracy. By integrating inputs from multiple sensors—specifically the IMU sensor 402, light sensor 404, and audio sensor 406—the decision engine 414 is able to build a more comprehensive and reliable picture of a potential crash event. This multi-modal approach solves the technical problem of single-sensor systems, which can be easily misled by isolated events (e.g., a loud noise without an accompanying impact signature). This data fusion allows the system to cross-validate sensor readings, significantly reducing the likelihood of false positives and providing a technical effect of increased confidence in the final determination, while using reduced power since the system 400 does not make use of a visual sensor. Moreover, system 400 preserves privacy and reduces the use of computational resources.

FIG. 4B is a block diagram illustrating an exemplary system for identifying an in-vehicle presence of a user, according to at least one example implementation. The system 430 is designed to assess whether a user wearing a device, such as AR glasses, is inside a vehicle that is in motion. This determination is important for contextualizing impact detection, helping the broader system distinguish between a fall and a vehicle crash. The system 430 integrates and analyzes data streams from multiple sensors to achieve a robust and accurate assessment.

The system 430 utilizes three primary sensor inputs, a visual sensor 418, an audio sensor 406, and an IMU sensor 402. Each sensor provides a unique stream of data that is processed by a specialized identifier module. The visual sensor 418, which is typically a camera on the head-wearable device, provides visual cues to a vehicle environment identifier 428. This identifier is configured to analyze the video or image feed for visual evidence characteristic of a vehicle interior, such as a dashboard, steering wheel, car seats, or the motion of scenery passing by windows. This may be achieved by utilizing an AI model such as a vision AI model or by using other logic.

Concurrently, the audio sensor 406, which may be a microphone, captures ambient sounds and sends this data to a vehicle audio identifier 420. This module is responsible for analyzing the audio cues to detect sounds commonly associated with a moving vehicle. Examples of such sounds include engine noise, the hum of tires on pavement, wind noise at high speeds, or even the sound of a car radio. By identifying these characteristic audio patterns, the system gains another layer of evidence suggesting the user is inside a vehicle.

The third input comes from the IMU sensor 402, which provides movement data to a vehicle signature identifier 422. This identifier analyzes motion patterns from the IMU sensor 402 to detect signatures consistent with being in a vehicle. These signatures could include subtle, persistent vibrations from the engine, the characteristic accelerations and decelerations of traffic, or the swaying motions of turning.

By combining these three specialized identifiers, the vehicle environment identifier 428, the vehicle audio identifier 420, and the vehicle signature identifier 422, the system 430 can make a highly reliable determination about the user's context. The outputs from each of these identifiers are synthesized by the in-vehicle presence identifier 424, which processes the combined evidence to generate a final measurement parameter 426, indicating the probability that the user is in a moving vehicle. The in-vehicle presence identifier can be implemented using signal processing logic, a machine learning model, a classifier and/or a state diagram. In an example, the in-vehicle presence identifier 424 synthesizes the input from the multiple modules to make a final determination about the in-vehicle presence of the user. By combining data on movement, image, and sound the in-vehicle presence identifier 424 can make a more accurate assessment than any single sensor could alone.

Some of these implementations can provide various technical advantages such as improved accuracy and greater contextual robustness. By fusing data from visual, audio, and inertial sensors, the in-vehicle presence identifier 424 can make a highly reliable determination about the user's environment, solving the technical problem of ambiguity that arises from single-sensor systems. For instance, an IMU alone might misinterpret road vibrations, but when combined with the visual confirmation of a car interior and the sound of an engine, the system's confidence in detecting an in-vehicle state increases significantly. This multi-modal approach creates a technical effect of enhanced reliability, ensuring that the appropriate impact detection model (e.g., crash vs. fall) is applied, thereby improving the overall accuracy of the system.

In some implementations, a fall detection system and/or a crash detection system can be tested using a variety of methods. In some implementations, a robotic dropping station can be configured to test fall detection. For example, a robot arm can be configured to pick up a device under test (DUT) at any position on the platform and drop the DUT at a designed orientation from, for example, up to 2 meters height. In some implementations, a launching system can be used (e.g., in the case of crash detection). The launching system can include a pneumatic cylinder which can be configured to accelerate an end-effector to a high speed in a shot range. In some implementations, a robot arm can be configured to pick up a DUT at any position and place it on the launching system.

In some implementations, a loudspeaker (e.g., a side loudspeaker) can be configured to play the crashing sound to trigger the DUT microphones. At least some features (which can be implemented using an IMU) can include a freefall from up to 1 to 2 meters high, an impact (e.g., an impact on an object, an impact on various materials such as a floor), and a robot arm configured to mimic human head trajectory. At least some features (which can be implemented using a proximity sensor) can include engaging a sensor using a robot grip and/or user automatic triggers. In some implementations, a loudspeaker can be configured to trigger a microphone. Some implementations can be configured to use, for example, a display screen (e.g., a television screen) to play falling video (which can include use of a camera) and/or can be configured to use a global positioning system (GPS) on a companion device (e.g., a phone) to detect a stop in motion. Some implementations can be configured to use, for example, a display screen (e.g., a television screen) to play a car crash video. In some implementations, an overwriting of some inputs can be done for a combination test. In some implementations, the testing mechanisms can be used to generate training data for training one or more models used in the systems disclosed herein.

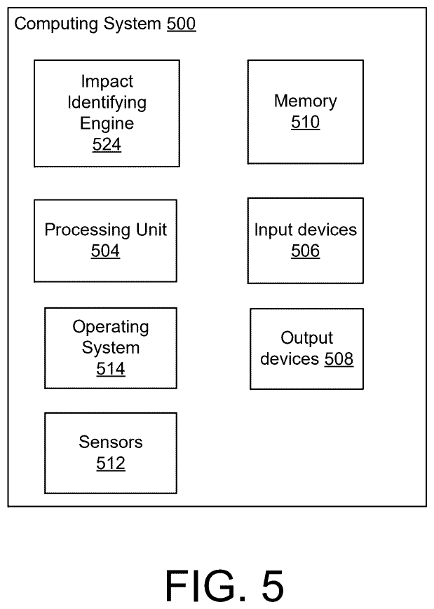

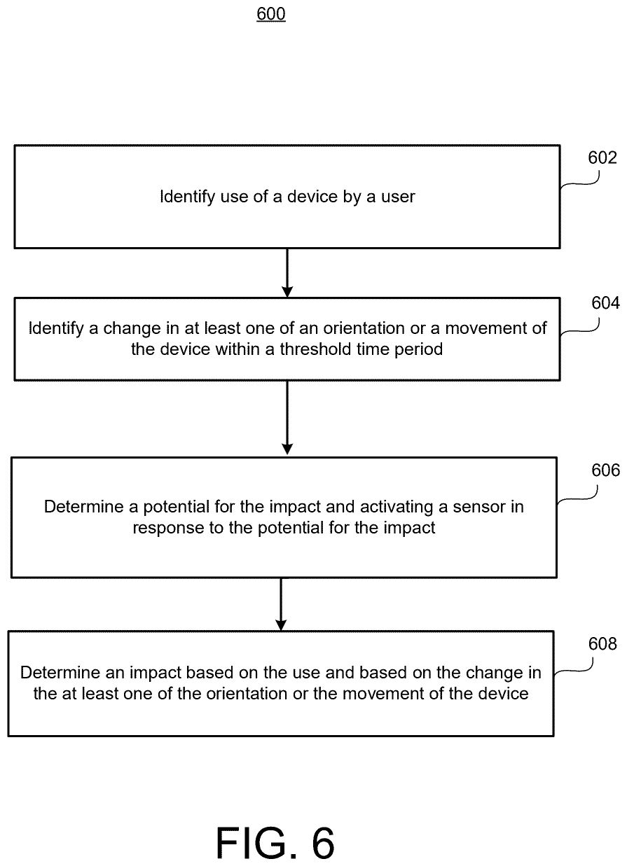

FIG. 5 is a block diagram illustrating an exemplary computing system for impact identification, according to at least one example implementation. In general, the computing system 500 can represent any computing device that executes a process such as the process 600 of FIG. 6 or executes a system such as the system 100, 200, 240, 250, 300, 400 or 430 of FIGS. 1, 2A-2C, 3 and 4A-4B. Although not all shown in FIG. 5, the computing system 500 may include several hardware components including a communication module (not shown), a memory 510, a processing unit 504, such as a central processing unit (CPU), a neural processing unit (NPU) and/or a graphics processing unit (GPU), one or more input devices 506 (e.g., touch screen, camera, stylus, microphone, keyboard, etc.), one or more output devices 508 (screen, display, speaker, vibrator, light emitter, etc.), and an operating system 514. The hardware components can be used to facilitate operation of the impact identifying engine 524, and/or other applications of the computing system 500. For example, elements of the impact identifying engine 524 can be stored on the memory 510, and the impact identifying engine 524 may be executed by the processing unit 504 (e.g., an NPU or CPU) to identify an impact. As such, the computing system 500 constitutes a special-purpose computing device, its standard hardware components are specially configured by computer-executable instructions to implement the techniques described herein, or different or future versions thereof, thereby transforming what would be a general-purpose computer into a specialized and more efficient machine for impact identification.

The sensor 512 may include an IMU sensor, a proximity sensor, an audio sensor, a visual sensor or a light sensor. The sensor data may be provided to the impact identifying engine 524 to identify an impact. The impact identifying engine 524 may include a fall identifying system, a crash identifying system, a wear state identifying system and/or an in-vehicle presence identifying system.

The memory 510 may represent any kind of (or multiple kinds of) memory (e.g., RAM, flash, cache, disk, tape, etc.). In some examples (not shown), the memory 510 may include external storage, e.g., memory physically remote from but accessible by the computing system 500. The memory 510 can be a semiconductor-based memory.

The processing unit 504 may be a semiconductor-based processor. Each of the components 504, 506, 508, 510, 512 and 514 are interconnected using various busses, and may be mounted on a common motherboard or in other manners as appropriate. The processing unit 504 can process instructions for execution within the computing system 500, including instructions stored in the memory 510. In other implementations, multiple processors and/or multiple buses may be used, as appropriate, along with multiple memories and types of memory.

The operating system 514 is a system software that manages computer hardware and software resources and provides common services for computing programs. In some examples, the operating system 514 is operable to run on a computing device such as a head-wearable device. The operating system 514 may include a plurality of modules that enable the operations of the computing system 500

FIG. 6 is a flowchart illustrating an exemplary method for determining an impact, according to at least one example implementation. In some implementations, process 600 may be performed by a computing device, such as the computing system 500 of FIG. 5 or the system 100 of FIG. 1B or system 300 of FIG. 3. Although the process 600 of FIG. 6 is explained with respect to the systems 100 and 300 of FIGS. 1 and 3, the process 600 may be applicable to any of the implementations discussed herein. Although process 600 of FIG. 6 illustrates the operations in sequential order, it will be appreciated that this is merely an example, and that additional or alternative operations may be included. Further, operations of FIG. 6 and related operations may be executed in a different order than that shown, or in a parallel or overlapping fashion.

Process 600 may begin by identifying use of a device by a user, at step 602. This may involve use of a wear state identification system such as the system 250 of FIG. 2C and/or use of a wear identifier such as the wear identifier 114 of FIG. 1B. The process may involve examining sensor data such as proximity and/or IMU sensor data to determine if the sensor data corresponds with a wear state. The wear state indicates that the user is actively using the device. This may be used as a first determination before the system makes further determinations. This can increase efficiency and accuracy by both reducing unnecessary processing and power use and reducing the number of false positives identifications.

After use of the device by the user is identified, process 600 proceeds to identify a change in at least one of an orientation or a movement of the device within a threshold time period, at step 604. This may involve examining IMU sensor data to determine if a change in the movement and/or orientation of the device within a threshold period of time (e.g., quick change in movement or orientation) corresponds with a potential fall or crash.

Once a change in the orientation and/or movement of the device within a threshold time period is identified, process 600 may determine a potential for the impact and activate a sensor in response to the potential for the impact, at step 606. This may occur when the process first identifies a potential for impact and then activates a sensor such as a visual or audio sensor to confirm the impact. For example, the process may examine the orientation and movement data and once data is indicative of a potential impact, the system may activate the additional sensor with a low enough latency such that the sensor can capture the impact event. Even if the sensor is activated after the impact event, the sensor data may still be useful in verifying the fall event. For example, image data received from a visual sensor such as a camera may indicate that the user is on the ground, confirming a fall event.

After a potential for the impact has been identified and the sensor has been activated, process 600 may proceed to determine an impact based on the use state (e.g., wear state) of the device, based on the change in the at least one of the orientation or the movement of the device and/or based on the data received from the sensor, at step 608. In some implementations, the process does not determine the potential impact and/or does not activate the sensor and simply determines the impact based on the use state and the change in the orientation and/or the movement of the device. The impact may be a fall or a crash. In some implementations, in addition to determining use of the device, a vehicle use is also determined to differentiate between a fall or a crash. For example, a system may be used to determine if the user is in a moving vehicle and activate a fall detection mechanism to look for potential crashes. Determining whether the user is in the moving vehicle may be done based on at least one of an IMU sensor, an audio sensor (e.g., a microphone), or a visual sensor (e.g., a camera). In some examples, determining impact is also based on data from a light sensor and based on examining light fluctuations.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent exemplary functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

In one aspect, a non-transitory computer-readable medium stores instructions that, when executed by a processor on a receiving computing device, causes the receiving computing device to perform any of the methods disclosed herein.

In one aspect, a computing device can be configured with at least one processor and memory storing instructions that, when executed by the at least one processor, perform any of the methods disclosed herein.

The following paragraphs provide various examples of the implementations disclosed herein.

In one aspect, a method involves identifying that a device is being used by a user, identifying a change in the orientation or movement of the device, and then determining that an impact has occurred based on both the device's use and the change in its orientation or movement.

In another aspect, the method further includes determining that there is a potential for an impact and, in response, activating a sensor.

In another aspect, detecting the change in the device's orientation or movement is based on an impact signature.

In another aspect, the method further includes activating a visual sensor in response to detecting the change, and determining the impact is based on the use of the device and on either the change itself or data received from the visual sensor.

In another aspect, the use of the device is associated with a context, which can be either a vehicular use or a non-vehicular use.

In another aspect, the device is a head-wearable device, and identifying its use involves detecting that the user is wearing the head-wearable device.

In another aspect, detecting that the head-wearable device is being worn by the user is based on data from a proximity sensor, an IMU, or both.

In another aspect, the method further includes determining if the user is in a moving vehicle, where the determination of an impact is also based on this information.

In another aspect, determining whether the user is in a moving vehicle is based on data from at least one of an inertial measurement unit (IMU) sensor, an audio sensor, or a visual sensor.

In another aspect, determining the impact is also based on data from a light sensor or an audio sensor.

In one aspect, a head-wearable device is provided, which includes a sensor, at least one processor, and a memory. The memory stores instructions that, when executed, cause the device to identify its use by a user based on data from the sensor, identify a change in its orientation or movement within a time period, and determine an impact based on both its use and the change in its orientation or movement.

In another aspect, the sensor is a first sensor, and the instructions further cause the head-wearable device to determine a potential for an impact and activate a second sensor in response.

In another aspect, the instructions further cause the head-wearable device to activate a visual sensor in response to detecting the change and to determine the impact based on the use and on either the change itself or data received from the visual sensor.

In another aspect, the use of the head-wearable device corresponds with a context of the use, which includes either a vehicular use or a non-vehicular use.

In another aspect, detecting the use of the head-wearable device includes detecting that the device is being worn by the user.

In one aspect, a non-transitory computer-readable medium is provided, storing instructions that, when executed by a processor on a computing device, cause the device to identify a change in its orientation or movement. The instructions also cause the device to determine a potential for an impact based on that change, activate a sensor in response to the potential impact, and determine the impact based on the change in orientation, the change in movement, or data received from the sensor.

In another aspect, the activated sensor is a visual sensor.

In another aspect, the instructions further cause the computing device to determine whether a user of the device is in a moving vehicle, where the impact determination is also based on whether the user is in the moving vehicle.

In another aspect, the instructions further cause the computing device to identify that it is being used by a user, wherein determining the impact is also based on the use of the computing device.

In another aspect, the computing device is a head-wearable device, and detecting its use involves detecting that the head-wearable device is being worn by the user.

What is claimed is:

1. A method, comprising:
identifying whether a device is being used by a user;
in response to identifying the device is being used by the user, identifying a change in at least one of an orientation or a movement of the device; and
determining a deceleration that satisfies a criterion based on the change in at least one of the orientation or the movement of the device.

2. The method of claim 1, further comprising:
determining a potential for an impact; and
activating a sensor in response to the potential for the impact.

3. The method of claim 1, wherein the deceleration that satisfies the criterion indicates an impact.

4. The method of claim 1, wherein the criterion is a profile associated with at least one of the orientation or the movement.

5. The method of claim 4, wherein the deceleration is included in the profile associated with at least one of the orientation or the movement.

6. The method of claim 1, wherein the criterion is a first criterion, the method further comprising:
determining an acceleration that satisfies a second criterion; and
responsive to determining the acceleration, determining the deceleration satisfies the first criterion based on the change in at least one of the orientation or the movement of the device.

7. The method of claim 1, wherein identifying whether the device is being used by the user includes identifying a type of activity in which the user is engaged.

8. The method of claim 7, wherein the type of activity includes at least one of a physical activity, a gaming activity, or a driving activity.

9. The method of claim 1, wherein the device is a first device, and determining the deceleration that satisfies the criterion is based on at least one of the change in at least one of the orientation or the movement of the first device or a change in at least one of an orientation or movement of a second device.

10. The method of claim 1, further comprising:
activating a visual sensor in response to detecting the change; and
determining the deceleration based on at least one of the change or the movement and based on data received from the visual sensor.

11. The method of claim 1, wherein identifying whether the device is being used by the user includes identifying a vehicular use or a non-vehicular use.

12. The method of claim 1, wherein the device is a head-wearable device and identifying whether the device is being used includes detecting that the head-wearable device is being worn by the user.

13. The method of claim 12, wherein detecting that the head-wearable device is being worn by the user is based on at least one of a proximity sensor or an inertial measurement unit (IMU).

14. The method of claim 1, further comprising:
determining whether the user is in a moving vehicle,
wherein determining the deceleration is further based on whether the user is in the moving vehicle.

15. The method of claim 14, wherein determining whether the user is in the moving vehicle is based on at least one of an inertial measurement unit (IMU) sensor, an audio sensor, or a visual sensor.

16. The method of claim 1, wherein determining the deceleration is further based on at least one of a light sensor or an audio sensor.

17. A head-wearable device comprising:
a sensor;
at least a processor; and
a memory storing instructions that, when executed by the processor, cause the head-wearable device to perform operations including:
identifying use of the head-wearable device by a user based on data received from the sensor;
identifying a change in at least one of an orientation or a movement of the head-wearable device within a time period; and
determining a deceleration that satisfies a criterion based on the use and based on the change in at least one of the orientation or the movement of the head-wearable device.

18. The head-wearable device of claim 17, wherein the sensor is a first sensor, the deceleration indicates an impact and the instructions further cause the head-wearable device to perform operations including:
determining a potential for the impact and activating a second sensor in response to the potential for the impact.

19. The head-wearable device of claim 17, wherein the instructions further cause the head-wearable device to perform operations including:
activating a visual sensor in response to detecting the change; and
determining the deceleration based on the use and based on at least one of the change and based on data received from the visual sensor.

20. The head-wearable device of claim 17, further comprising a microcontroller, wherein the data from the sensor is provided to the microcontroller for processing to conserve power.

21. A non-transitory computer-readable medium storing instructions that, when executed by a processor on a computing device, causes the computing device to perform operations comprising:
identifying a change in at least one of an orientation or a movement of the computing device;
determining a potential for an impact based on the change in at least one of the orientation or the movement of the computing device;
activating a sensor in response to the potential for the impact; and
determining the impact based on the change in at least one of the orientation or the movement of the computing device or data received from the sensor.

22. The non-transitory computer-readable medium of claim 21, wherein the sensor is a visual sensor.

23. The non-transitory computer-readable medium of claim 21, wherein the instructions when executed by the processor on the computing device, further cause the computing device to perform operations comprising:
determining whether a user of the computing device is in a moving vehicle,
wherein determining the impact is further based on whether the user is in the moving vehicle.
